(19) United States
(12) Patent Application Publication
(10) Pub. No.: US 2011/0207096 A1
(43) Pub. Date: Aug. 25, 2011

(54) TRAINING APPARATUS, TRAINING SUPPORTING METHOD, AND TRAINING SYSTEM

(75) Inventors: Takesi Kawaguti, Shizuoka (JP); Masanori Sambe, Shizuoka (JP)

(73) Assignee: TOSHIBA TEC KABUSHIKI KAISHA, Tokyo (JP)

(21) Appl. No.: 13/020,039

(22) Filed: Feb. 3, 2011

(30) Foreign Application Priority Data
Feb. 19, 2010 (JP) 2010-035118

(51) Int. Cl. G09B 19/00

(52) U.S. Cl. 434/219

(57) ABSTRACT

In one embodiment, a training apparatus includes first to third control units, an input device, and a determining unit. The first control unit controls a display device to display an input interface image, which imitates an external appearance of a user interface for inputting operation in an input apparatus. The second control unit controls the display device to play a moving image representing opportunity event, which is an opportunity for the operation, or continuously display plural still images including still image concerning the opportunity event. The input device inputs operation by an operator on the input interface image. The determining unit determines consistency between at least one kind of the operation input by the input device and at least one kind of specified operation. The third control unit controls the display device to display a result image representing a determination result in the determining unit.

### CROSS-REFERENCE TO RELATED APPLICATIONS

This application is based upon and claims the benefit of priority from Japanese Patent Application No. 2010-035118, filed Feb. 19, 2010; the entire contents of which are incorporated herein by reference.

### FIELD

Embodiments described herein relate generally to a training apparatus, a training supporting method, and a training system.

### BACKGROUND

In a large number of restaurants such as a family restaurant and a bar, a processing apparatus that executes processing concerning various jobs such as reception of orders of menu items and checkout is used.

A user such as a store clerk inputs operation to the processing apparatus using an input apparatus and the processing apparatus executes processing corresponding to the input operation.

Specifically, in the case of a system used in the restaurants, the input apparatus and the processing apparatus are respectively, for example, an order terminal and a station (a server). In this case, the user inputs operation for designating menu items ordered by a customer to the order terminal. The order terminal generates order reception information including a list of the ordered menu items on the basis of the input operation and transmits the order reception information to the station. The station performs creation of a cooking instruction slip, sales management processing, and the like on the basis of the order reception information.

Proficiency in operation in the input apparatus by the user is realized in an actual job or realized in a simulative job in which another store clerk plays the role of a customer.

Therefore, in the past, there are deficiencies in that the actual job is inappropriately performed on the basis of operation in the input apparatus by an unaccustomed user and labor and time of others are required for proficiency of one user.

Under such circumstances, it is desired to easily realize proficiency in operation in the input device.

### BRIEF DESCRIPTION OF THE DRAWINGS

FIG. 1 is a diagram of the configuration of an order processing system according to an embodiment;

FIG. 2 is a block diagram of an information terminal shown in FIG. 1;

FIG. 3 is a schematic diagram of an example of a training course database;

FIG. 4 is a schematic diagram of an example of a training state database;

FIG. 5 is a flowchart for explaining training processing by a CPU shown in FIG. 2;

FIG. 6 is a diagram of an example of a display screen including a course selection image;

FIG. 7 is a diagram of an example of a display screen including a training image;

FIG. 8 is a diagram of an example of a display screen including a course selection image; and

FIG. 9 is a diagram of the configuration of a training system that uses a cloud system.

### DETAILED DESCRIPTION

In general, according to one embodiment, a training apparatus includes first to third control units, an input device, and a determining unit. The first control unit controls a display device to display an input interface image, which imitates an external appearance of a user interface for inputting operation in an input apparatus, in a first display area of the display device. The second control unit controls the display device to play a moving image representing at least one opportunity event, which is an opportunity for the operation, or continuously display plural still images including at least one still image concerning the opportunity event in a second display area of the display device. The input device inputs operation by an operator on the input interface image. The determining unit determines consistency between at least one kind of the operation input by the input device and at least one kind of specified operation. The third control unit controls the display device to display a result image representing a determination result in the determining unit.

An embodiment is explained below with reference to the accompanying drawings.

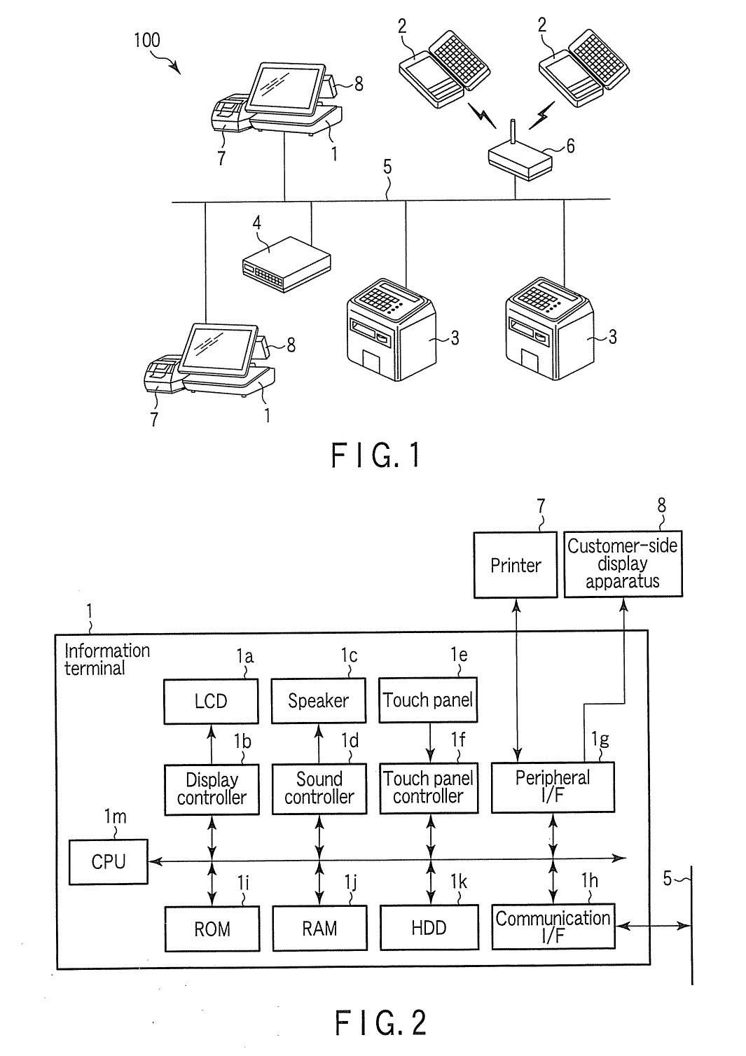

FIG. 1 is a diagram of the configuration of an order processing system 100 according to this embodiment.

The order processing system 100 can be used in various facilities that provide eating and drinking services and commodity sales services according to orders of customers such as a restaurant and a store. However, in the following explanation, the order processing system 100 adapted to use in the restaurant is explained.

The order processing system 100 is configured by connecting plural information terminals 1, plural handy terminals 2, plural slip printers 3, and a station 4 to a LAN (local area network) 5. However, the handy terminals 2 are connected to the LAN 5 via a wireless access point 6. In FIG. 1, two each of the information terminals 1, the handy terminals 2, and the slip printers 3 are shown. However, the numbers thereof are respectively arbitrary. Only one each of the information terminal 1, the handy terminal 2, and the slip terminal 3 may be provided.

The information terminals 1 are set in, for example, a customer service floor and a checkout counter. The information terminals 1 perform processing concerning various jobs such as customer attendance, order reception, service at table (table setting), and checkout. In the information terminal 1 set in the customer service floor, the processing concerning customer attendance, order reception, and service at table (table setting) is mainly used. In the information terminal 1 set in the checkout counter, processing concerning checkout is further used. The information terminal 1 may be specialized for specific uses by performing processing concerning only a part of the jobs. At least one of the information terminals 1 has a function of executing training processing explained later and functions as a training apparatus.

The handy terminals 2 include user interfaces on which plural operation keys such as soft keys and hard keys are arrayed. Operation by users for order input is input by the user interfaces. The handy terminals 2 generate order information according to the input operation and transmit the order information by radio. The order information transmitted from the handy terminals 2 by radio is transmitted to the station 4 via the wireless access point 6 and the LAN 5.

The slip printers 3 are set in, for example, the customer service floor and a kitchen. The slip printer 3 set in the customer service floor prints, for a customer, an order slip based on order reception information. In other words, the slip printer 3 set in the customer service floor is used as a so-called customer printer. The slip printer 3 set in the kitchen prints, for a cook, a cooking instruction slip based on the order reception information. In other words, the slip printer 3 set in the kitchen is used as a so-called kitchen printer.

The station 4 is set in, for example, a backyard. The station 4 subjects various kinds of information transmitted from the information terminals 1 to totalizing processing and performs processing concerning management related to business of the restaurant. In some case, the station 4 performs management processing for information used in common in the plural information terminals 1.

FIG. 2 is a block diagram of the information terminal 1.

The information terminal 1 includes a liquid crystal display (LCD) 1a, a display controller 1b, a speaker 1c, a sound controller 1d, a touch sensor 1e, a touch sensor controller 1f, a peripheral interface (peripheral I/F) 1g, a communication interface (communication I/F) 1h, a ROM (read-only memory) 1i, a RAM (random-access memory) 1j, a HDD (hard disk drive) 1k, and a CPU (central processing unit) 1m. The display controller 1b, the sound controller 1d, the touch sensor controller 1f, the peripheral interface 1g, the communication interface 1h, the ROM 1i, the RAM 1j, the HDD 1k, and the CPU 1m are connected to a bus line. The LCD 1a, the speaker 1c, and the touch sensor 1e are respectively connected to a display controller 1b, a sound controller 1d, and a touch sensor controller 1f.

The LCD 1a is driven by the display controller 1b and displays an image. The display controller 1b drives the LCD 1a such that an image corresponding to image data transferred under the control by the CPU 1m is displayed.

The speaker 1c is driven by the sound controller 1d and generates sound. The sound controller 1d drives the speaker 1c such that sound corresponding to sound data transferred under the control by the CPU 1m is generated.

The touch sensor 1e is laminated and arranged on a display surface of the LCD 1a. When a user (an operator) touches a display screen of the LCD 1a, the touch sensor 1e outputs a detection signal corresponding to a position touched by the user. The touch sensor controller 1f calculates coordinate information representing the touched position on the basis of the detection signal output from the touch sensor 1e and sends the coordinate information to the CPU 1m.

Peripherals such as a printer 7 and a customer-side display apparatus 8 are connected to the peripheral interface 1g according to necessity. The peripheral interface 1g communicates with the peripherals connected thereto. As the peripheral interface 1g, for example, an interface circuit conforming to a general-purpose standard of a USB (universal serial bus) can be used. The printer 7 is used for printing an order reception slip, a receipt, various journals, and the like. The customer-side display apparatus 8 is used for displaying images for presenting a checkout result, advertisement information, and the like to a customer. At least one of the printer 7 and the customer-side display apparatus 8 may be incorporated in the information terminal 1.

The communication interface 1h communicates with the slip printer 3 and the station 4 via the LAN 5. As the communication interface 1h, for example, an interface circuit conforming to a general-purpose standard of an Ethernet (registered trademark) or the like can be used.

The ROM 1i has stored therein, for example, a computer program that describes a processing procedure of the CPU 1m and data necessary for the CPU 1m to execute various kinds of processing.

The RAM 1j stores, according to necessity, data necessary for the CPU 1m to execute the various kinds of processing. For example, image information representing an image displayed on the LCD 1a is stored in the RAM 1j. The RAM 1j is also used as a work area for the CPU 1m to perform the various kinds of processing.

The HDD 1k has stored therein, for example, the computer program that describes the processing procedure of the CPU 1m and the data necessary for the CPU 1m to execute the various kinds of processing. The HDD 1k has stored therein a database concerning menu items provided in the restaurant in which the order processing system 100 is set. The HDD 1k has stored therein data of an input interface image that imitates the user interfaces in the handy terminals 2. The HDD 1k has stored therein a training course database that describes contents of respective plural training courses. The HDD 1k has stored therein a training state database that describes training states concerning respective plural store clerks. Further, the HDD 1k has stored therein plural moving image files played in training processing.

The CPU 1m executes, according to the computer program stored in the ROM 1i and the HDD 1k, the various kinds of processing concerning the various jobs and the training processing.

The information terminal 1 may be sold or transferred in a state in which the computer program is stored in the ROM 1i and the HDD 1k. The computer program stored in a storage medium or sold or transferred by communication via a communication line may be arbitrarily installed in the information terminal 1. As the storage medium, all kinds of storage medium such as a magnetic disk, a magneto-optical disk, an optical disk, and a semiconductor memory can be used.

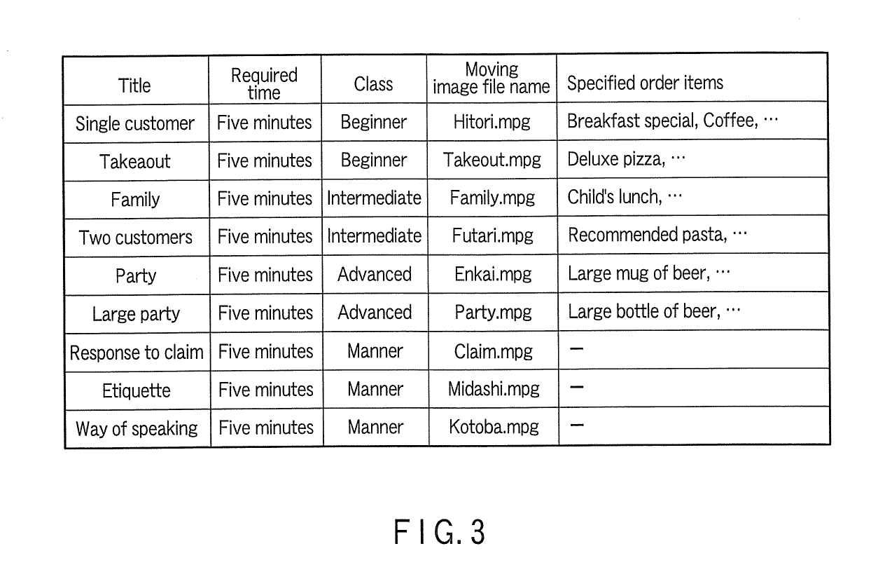

FIG. 3 is a schematic diagram of an example of the training course database.

As shown in FIG. 3, the training course database includes data records respectively corresponding to plural training courses. Each of the data records includes information fields concerning a title, a required time, a class, a moving image file name, and specified order items. Information described in the information field concerning the title represents a title for identifying a training course. Information described in the information field concerning the required time represents a required time of each kind of training. Information described in the information field concerning the class represents information representing a degree of difficulty. Information described in the information field concerning the moving image file name represents an identification name of a moving image file that should be used. Information described in the information field concerning the specified order items represents items that should be input as ordered items.

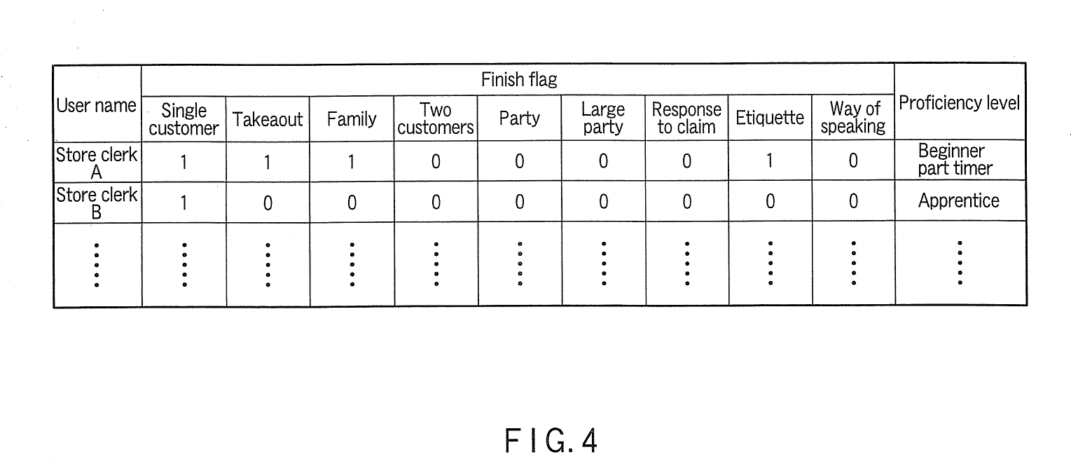

FIG. 4 is a schematic diagram of an example of the training state database.

As shown in FIG. 4, the training state database includes data records corresponding to respective plural users (store clerks). Each of the data records includes information fields concerning a user name, a finish flag for each of the training courses, and a proficiency level. Information described in the information field concerning the user name represents a name for identifying a user. The finish flag represents a finish state of training of each of the training courses as 0 (not finished) or 1 (finished). Information described in the information field concerning the proficiency level represents a proficiency level representing a degree of proficiency concerning the operation of the handy terminal 2.

The operation of the order processing system 100 is explained below.

When a user performs operation for order input in the information terminal 1 or the handy terminal 2, order information generated by the information terminal 1 or the handy terminal 2 according to the operation is transmitted to the station 4 via the LAN 5. The station 4 manages the transmitted order information for checkout processing, totalizing processing, and the like. The station 4 transmits the order information to the slip printer 3 via the LAN 5. The slip printer 3 prints a cooking instruction slip and an order slip including contents corresponding to the transmitted order information.

A user who desires to train the user herself or himself in the operation in the handy terminal 2 can use a training function of the information terminal 1.

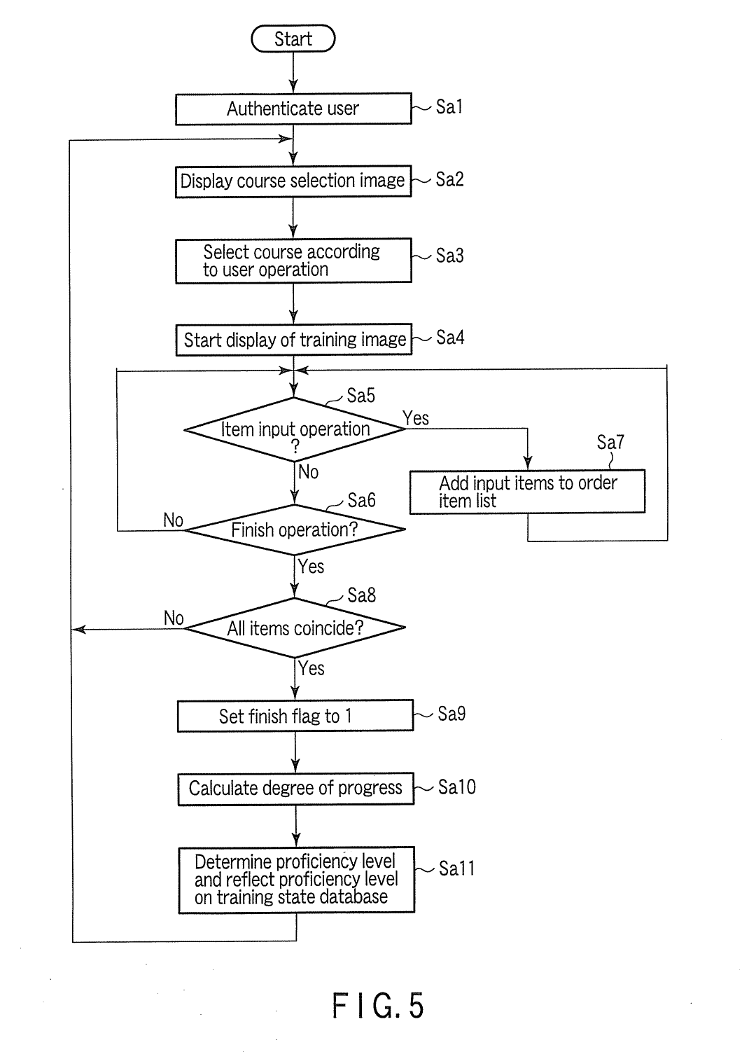

In the information terminal 1 requested by the user to start the training function, the CPU 1m executes training processing shown in FIG. 5.

In Act Sa1, the CPU 1m authenticates the user.

In Act Sa2, the CPU 1m generates a course selection image and instructs the display controller 1b to display the course selection image. According to the instruction, the display controller 1b drives the LCD 1a to display the course selection image.

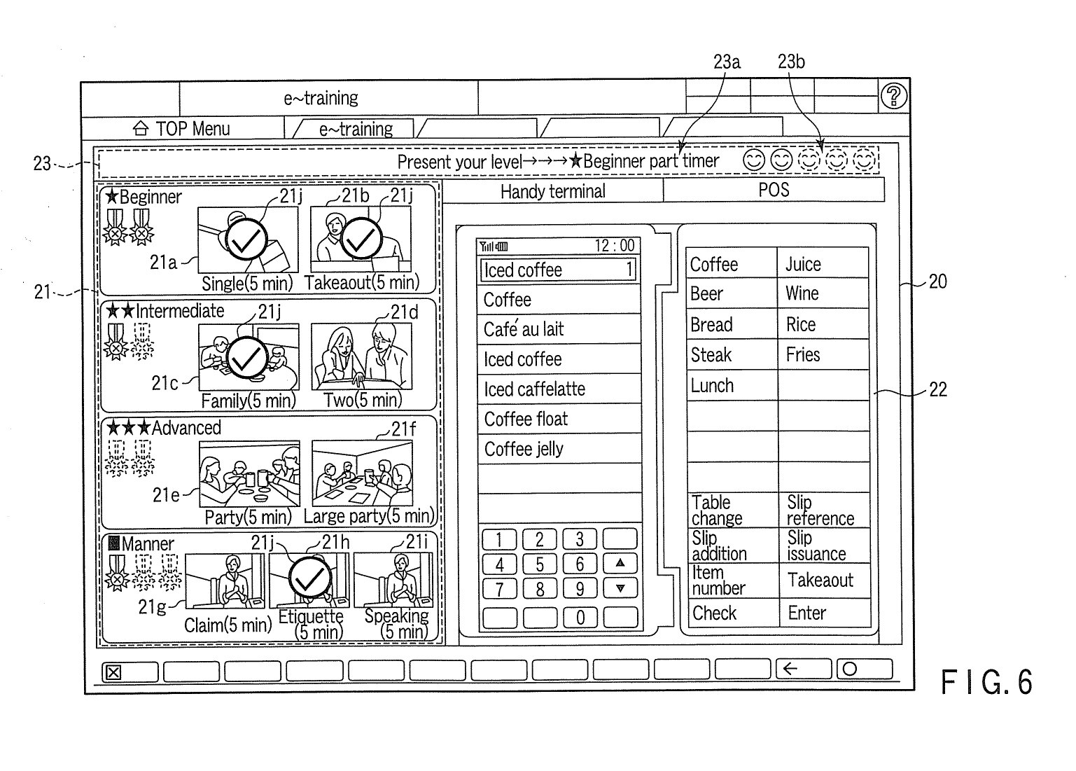

FIG. 6 is a diagram of an example of a display screen including a course selection image 20.

The course selection image 20 includes a course list image 21, an input interface image 22, and a guide image 23.

The course list image 21 shows a list of training courses registered in the training course database. In the example shown in FIG. 6, the course list image 21 includes moving image thumbnails 21a, 21b, 21c, 21d, 21e, 21f, 21g, 21h, and 21i of the training courses. The course list image 21 includes texts representing titles and required times of the training courses under the moving image thumbnails 21a to 21i. The course list image 21 classifies and shows the moving image thumbnails 21a to 21i for each of classes of the training courses.

Further, the course list image 21 includes finish marks 21j, which represents that training is finished, superimposed on the moving image thumbnails of the training courses in which the finish flags described in the training state database is “1” concerning the user authenticated in Act Sa1. In the training state database shown in FIG. 4, the finish flags are “1” concerning a user “store clerk A” in the training courses “single customer”, “takeaway”, “family”, and “etiquette”. In FIG. 6, according to the training state database, the course list image 21 includes the finish marks 21j respectively superimposed on the moving image thumbnails 21a, 21b, 21c, and 21h concerning the training courses “single customer”, “takeaway”, “family”, and “etiquette”.

The input interface image 22 is an image that imitates the external appearance of the user interfaces in the handy terminals 2.

The guide image 23 includes a character string 23a and a mark 23b representing a proficiency level of the user.

In Act Sa3, the CPU 1m selects one of the training courses according to user operation. Specifically, according to the user's operation for touching one of the moving image thumbnails included in the course list image 21, the CPU 1m selects a training course concerning the touched moving image thumbnail. For example, if the user performs operation for touching a display area of the moving image thumbnail 21d in FIG. 6, the CPU 1m selects a training course with a title “two customers”.

In Act Sa4, the CPU 1m starts display of a moving image corresponding to the selected training course.

For example, if the training course with the title “two customers” is selected, the CPU 1m acquires “Futari.mpg” as a moving image file name according to the training course database, generates a training image including a moving image based on a moving image file stored in the HDD 1k in this file name, and instructs the display controller 1b to display the training image. According to the instruction, the display controller 1b drives the LCD 1a to display the training image. The CPU 1m instructs the sound controller 1d to generate sound corresponding to sound data included in the moving image file. According to the instruction, the sound controller 1d drives the speaker 1c to generate the sound.

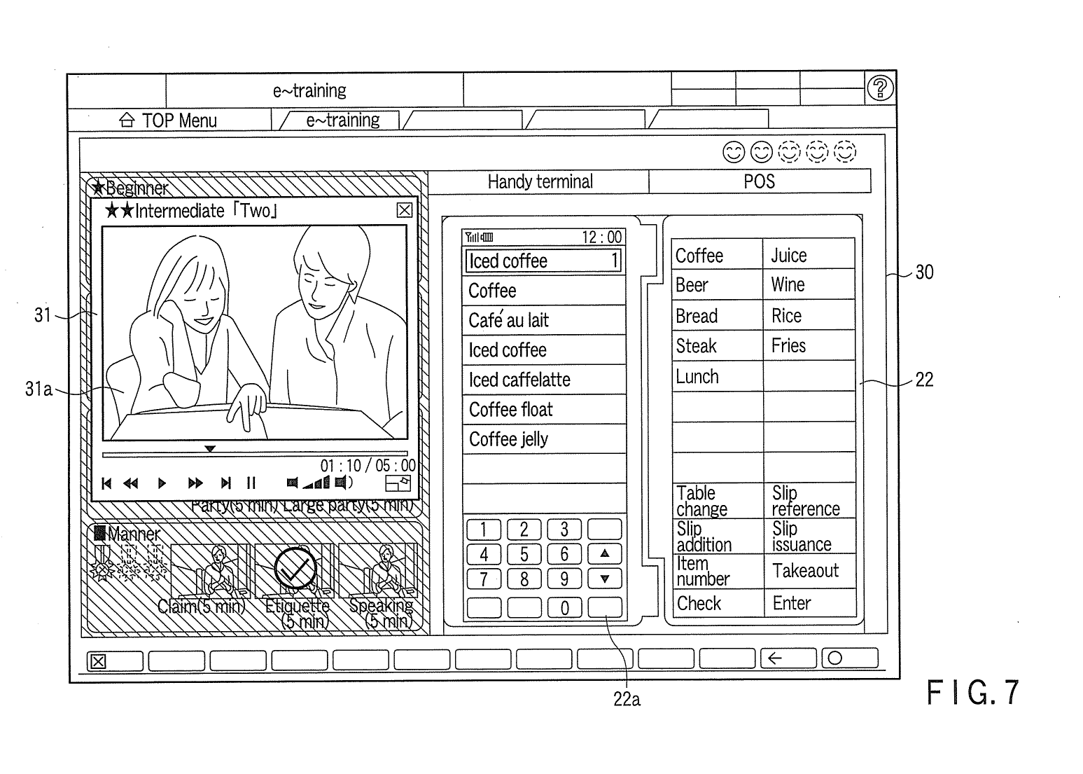

FIG. 7 is a diagram of an example of a display screen including a training image 30.

The training image 30 includes a player image 31 superimposed on the course list image 21 in the course selection image 20. The player image 31 includes a moving image 31a. The CPU 1m sequentially selects, as display targets, a large number of image frames, which are represented by moving image files, one by one at a fixed time interval and automatically changes the moving image 31a to an image frame set as the display target. A moving image and sound represented by the moving image file represent plural events over time that are opportunities for the user to perform operation for inputting menu items in the handy terminal 2. Specifically, the moving image and the sound are, for example, a moving image obtained by photographing a state of ordering by a customer and an animation representing the same state.

The user touches, according to the moving image displayed by the LCD 1a and the sound generated by the speaker 1c, buttons of menu items arranged on the input interface image 22 to thereby perform item input operation for inputting ordered menu items. When the user thinks that the input of all the ordered menu items is completed, the user performs finish operation, for example, touches a transmission button 22a arranged in the input interface image 22.

In Act Sa5 and Act Sa6, the CPU 1m waits for item input operation or finish operation to be performed. If the item input operation is performed, the CPU 1m proceeds from Act Sa5 to Act Sa7. If the finish operation is not performed by finish timing set in advance as a point when the reproduction of the moving image is finished or a point when a fixed time elapses from the point when the reproduction of the moving image is finished, the CPU 1m may proceed from Act Sa5 to Act Sa7. In this case, the CPU 1m receives operations by the user in a period (operation period) from the starting timing of the play of the moving image to the finish timing.

In Act Sa7, the CPU 1m adds the menu items input by the item input operation to an order item list. Thereafter, the CPU 1m returns to the waiting state in Act Sa5 and Act Sa6.

When the finish operation is performed in the waiting state in Act Sa5 and Act Sa6, the CPU 1m proceeds from Act Sa6 to Act Sa8.

In Act Sa8, the CPU 1m checks whether all the menu items included in the order item list coincide with the menu items included in the specified order items described in the training course database concerning the currently-selected training course. If all the menu items coincide with the menu items included in the specified order items, the CPU 1m proceeds from Act Sa8 to Act Sa9.

In Act Sa9, the CPU 1m sets the finish flags included in the training state database concerning the currently-selected training course and the user authenticated in Act Sa1 to “1”.

In Act Sa10, the CPU 1m calculates a degree of progress of the training concerning the user authenticated in Act Sa1. The degree of progress only has to be calculated on the basis of arbitrary rules set in advance. For example, the degree of progress can be calculated as the number of training courses in which the finish flags are “1”. In this case, if the training state database is in a state shown in FIG. 4, the degree of progress concerning the user “store clerk A” is “4”. Alternatively, the degree of progress can be calculated as a sum of values calculated by multiplying the finish flags with a coefficient corresponding to a degree of difficulty of a training course. Specifically, if coefficients concerning “beginner's class”, “intermediate class”, “advanced class”, and “manner” are respectively set to “1”, “2”, “3”, and “1” according to classes of the training courses, if the training state database is in the state shown in FIG. 4, a degree of progress concerning the user “store clerk A” is “5”.

In Act Sa11, the CPU 1m determines a proficiency level according to the degree of progress and reflects the proficiency level on the training state database. Specifically, a correspondence relation between degrees of progress and proficiency levels is set in advance. The proficiency level is an index with which the user can recognize a degree of proficiency such as “part time beginner's class” and “part time intermediate class”. For example, if the proficiency level does not change even if the degree of progress rises, the CPU 1m does not change the training state database at all. However, for example, if the user reaches a new proficiency level according to the rise in the degree of progress, the CPU 1m changes description of the information field concerning the proficiency level of the training state database. More specifically, if the user “store clerk A” correctly completes the training course “two customers”, the CPU 1m determines that the proficiency level of the user is “part time intermediate class”. In this case, the CPU 1m updates the training state database to change description of the information filed concerning the proficiency level in a data record described as “store clerk A” in the information field of the user name, for example, from “part time beginner's class” to “part time intermediate class” shown in FIG. 4.

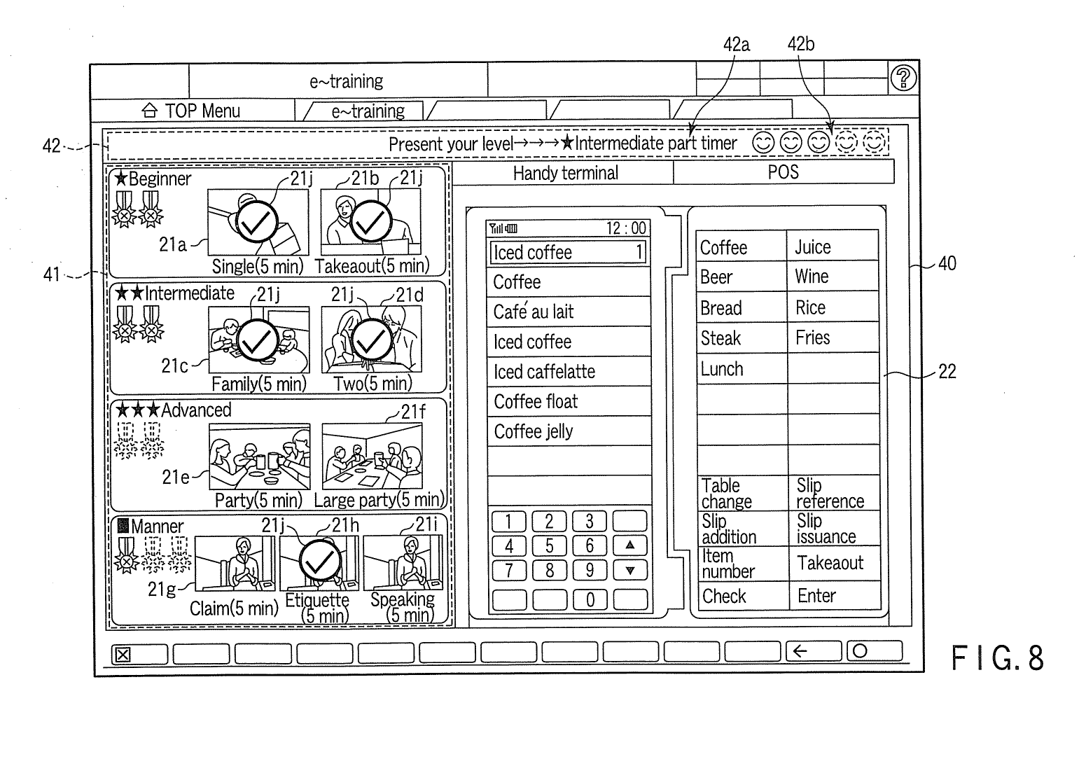

Thereafter, the CPU 1m returns to Act Sa2 and displays a course selection image again. At this point, the CPU 1m generates a course selection image on the basis of information described in the latest training state database. Therefore, for example, if the training state database is updated in the specific example explained above, the course selection image displayed again is an image shown in FIG. 8. In a course selection image 40 shown in FIG. 8, a course list image 41 is different from the course list image 21 in that the course list image 41 includes the finish mark 21j superimposed on the moving image thumbnail 21d. In the course selection image 40, a guide image 42 is different from the guide image 23 in that the guide image 42 includes a character string 42a and a mark 42b representing a proficiency level after change.

If inconsistency of the menu items is found in Act Sa8, the CPU 1m returns from Act Sa8 to Act Sa2. In this case, since the training state database is not updated, for example, the course selection image 20 shown in FIG. 6 is displayed again.

In this way, if all the menu items included in the order item list coincide with the menu items included in the specified order items, the CPU 1m determines that the operation by the user matches specified operation. Otherwise, the CPU 1m determines that the operation by the user does not match the specified operation. The CPU 1m controls display and non-display of the finish marks 21j on the LCD 1a to display a result of the determination.

When the information terminal 1 is used as explained above, the user can train the user herself or himself in the operation of the handy terminal 2 without requiring labor and time of others. The user can recognize, according to presence or absence of the finish marks 21j, whether correct operation was able to be performed.

The information terminal 1 provides the user with a proficiency level. Therefore, the user can easily and accurately grasp a degree of proficiency of the user concerning the operation of the handy terminal 2.

Various modifications of this embodiment are possible as explained below.

Menu items omitted to be input or menu items input by mistake may be discriminated by comparison of the menu items included in the order item list and the specified order items and an image for presenting the menu items to the user may be displayed.

An input interface image displayed on the LCD 1a when the information terminal 1 functions as a POS terminal may be used instead of the input interface image 22. If operation on the input interface image is input, it is possible to cause the user to perform training in the operation of the POS terminal.

Plural still images may be displayed in a slide-show format instead of the moving image. Specifically, the plural still images may be automatically selected as display targets in order and at a fixed time interval and the LCD 1a may be caused to display the still images selected as the display targets.

The information terminal 1 having the training function does not need to be an information terminal that perform processing concerning all jobs such as customer attendance, order reception, service at table (table setting), and checkout and may be an information terminal that performs processing different from the processing.

User operation set as a target of training is not limited to the operation for order input.

A training result is not limited to the training result determined according to whether the input operation and the specified operation completely coincide with each other. For example, the training result can be determined as a ratio of coincidence of the input operation and the specified operation. Further, for example, the training result may be determined also taking into account other kinds of information such as the order and timing of the input operation.

Rules for determining that the input operation and the specified operation have consistency can be arbitrarily set. The consistency may be determined taking into account a shift between timing when operation is input and timing when the operation should be performed.

The operations explained above can also be realized by a training system including terminal apparatuses and server apparatuses. In this case, one server apparatus may perform processing for realizing training of users in one or plural terminal apparatuses or plural server apparatuses may share processing for realizing training of users in one or plural terminal apparatuses.

Cloud computing can be used to realize such a training system. More specifically, software provision form called software as a service (SaaS) is suitable.

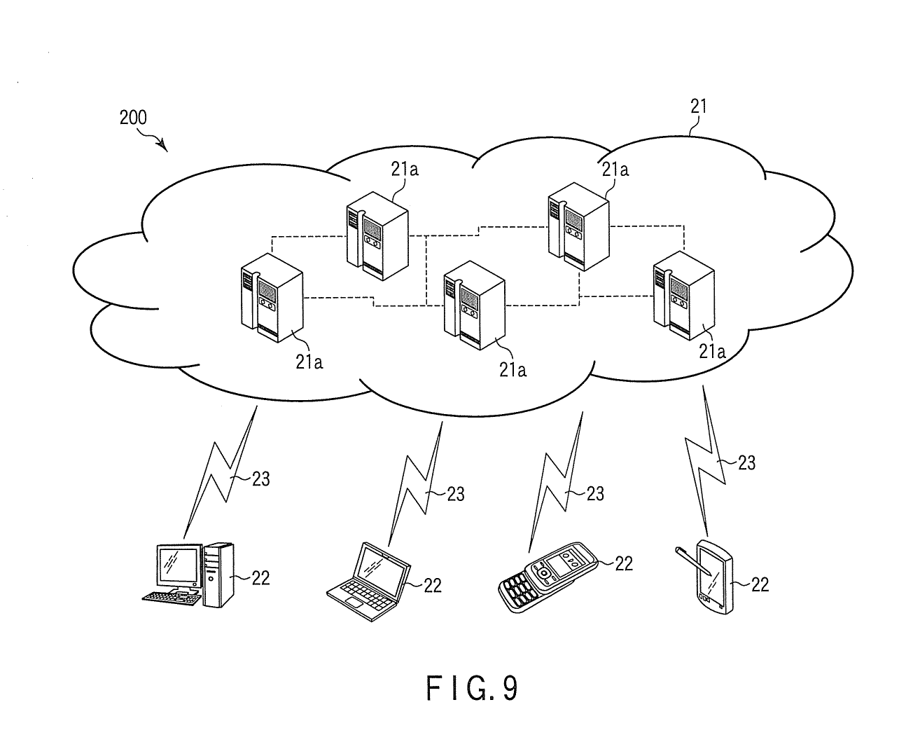

FIG. 9 is a diagram of the configuration of a training system 200 that uses a cloud system.

The training system 200 includes a cloud 21, plural terminal apparatuses 22, and plural communication networks 23. The training system 200 may include only one each of the terminal apparatus 22 and the communication network 23.

The cloud 21 further includes plural server apparatuses 21a. The plural server apparatuses 21a are configured to be capable of communicating with one another. However, the cloud 21 may include only one server apparatus 21a.

The terminal apparatuses 22 can communicate with the cloud 21 via the communication networks 23. As the terminal apparatuses 22, various computers such as a desk top computer and a notebook computer, a cellular phone, a personal digital assistant (PDA), a smart phone, and the like can be used as appropriate. As the communication networks 23, the Internet, a private network, a next generation network (NGN), a mobile network, and the like can be used as appropriate.

The training system 200 executes Act Sa1 and Act Sa2 in the processing shown in FIG. 5 respectively in the cloud 21 and the terminal apparatuses 22. However, the training system 200 may execute Acts Sa3 to Sa11 in any of the cloud 21 and the terminal apparatuses 22. The training system 200 may execute, for example, input of authentication information used for authenticating a user in Act Sa1 in the terminal apparatuses 22. The training system 200 may execute generation of a course selection image in Act Sa2 in the cloud 21.

If the training system 200 executes plural kinds of processing in Acts Sa3 to Sa11 in the cloud 21, the training system 200 may execute the kinds of processing in the single server apparatus 21a or may distributedly process the processing in the plural server apparatuses 21a.

If the training system 200 executes at least one kind of processing in Acts Sa3 to Sa11 in the terminal apparatus 22, a computer program for causing computers included in the terminal apparatuses 22 to execute the processing may be stored in storing units included in the terminal apparatuses 22 in advance. The computer program may be stored in a storing unit included in the cloud 21 and given from the cloud 21 to the terminal apparatuses 22 according necessity. If the computer program is given from the cloud 21 to the terminal apparatuses 22, at least one of the server apparatuses 21a has a function of transmitting the computer program to the terminal apparatuses 22.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A training apparatus that causes an operator to train the operator herself or himself in operation in an input apparatus, the training apparatus comprising:
a first control unit configured to control a display device to display an input interface image, which imitates an external appearance of a user interface for inputting the operation in the input apparatus, in a first display area of the display device;
a second control unit configured to control the display device to play a moving image representing at least one opportunity event, which is an opportunity for the operation, or continuously display plural still images including at least one still image concerning the opportunity event in a second display area of the display device;
an input device configured to input operation by the operator on the input interface image;
a determining unit configured to determine consistency between at least one kind of the operation input by the input device and at least one kind of specified operation; and
a third control unit configured to control the display device to display a result image representing a determination result in the determining unit.

2. The apparatus according to claim 1, further comprising the display device.

3. The apparatus according to claim 1, further comprising:
a generating device configured to generate sound; and
a fourth control unit configured to control the generating device to generate sound related to the moving image or the still images displayed by the display device under the control by the second control unit.

4. The apparatus according to claim 1, wherein
the second control unit selects any one of a plurality of the moving images or any one of plural still image groups and controls the display device to play the selected moving image or continuously display the plural still images included in the selected still image group,
the determining unit determines that the operation input by the input device and the specified operation have consistency if the all kinds of the operation input by the input device and the specified operations corresponding to the moving image or the still image group selected by the second control unit coincide with each other, and
the training apparatus further comprises a managing unit configured to manage, in association with each of the plural moving images or the plural still image groups, whether the determining unit determines that the operation and the specified operation have consistency.

5. The apparatus according to claim 4, further comprising:
a calculating unit configured to calculate a proficiency level on the basis of a ratio of the moving images or the still image groups in association with which the managing unit manages that the determining unit determines that the operation and the specified operation have consistency; and
a fifth control unit configured to control the display device to display a level image representing the proficiency level calculated by the calculating unit.

6. A training supporting method for causing an operator to train the operator herself or himself in operation in an input apparatus, the training supporting method comprising:
controlling a display device to display an input interface image, which imitates an external appearance of a user interface for inputting the operation in the input apparatus, in a first display area of the display device;
controlling the display device to play a moving image representing at least one opportunity event, which is an opportunity for the operation, or continuously display plural still images including at least one still image concerning the opportunity event in a second display area of the display device;
inputting operation by the operator on the input interface image;
determining consistency between at least one kind of the operation input and at least one kind of specified operation; and
controlling the display device to display a result image representing a result of the determination.

7. The method according to claim 6, further comprising:
selecting any one of a plurality of the moving images or any one of plural still image groups and controlling the display device to play the selected moving image or continuously display the plural still images included in the selected still image group;
determining that all kinds of the input operation and specified operation corresponding to the selected moving image or the selected still image group have consistency if the operation and the specified operation coincide with each other; and
managing, in association with each of the plural moving images or the plural still image groups, whether it is determined that the operation and the specified operation have consistency.

8. The method according to claim 7, further comprising:
calculating a proficiency level on the basis of a ratio of the moving images or the still image groups in association with which it is managed that the operation and the specified operation are determined as having consistency; and
controlling the display device to display a level image representing the calculated proficiency level.

9. A training system that includes at least one server apparatus and at least one terminal apparatus and causes an operator to train the operator herself or himself in operation in an input apparatus, the training system comprising:
a first control unit configured to control a display device to display an input interface image, which imitates an external appearance of a user interface for inputting the operation in the input apparatus, in a first display area of the display device;
a second control unit configured to control the display device to play a moving image representing at least one opportunity event, which is an opportunity for the operation, or continuously display plural still images including at least one still image concerning the opportunity event in a second display area of the display device;
an input device configured to input operation by the operator on the input interface image;
a determining unit configured to determine consistency between at least one kind of the operation input by the input device and at least one kind of specified operation; and
a third control unit configured to control the display device to display a result image representing a determination result in the determining unit, wherein
the server apparatus includes at least a part of the first control unit, the second control unit, the determining unit, and the third control unit, and
the terminal apparatus includes the units not included in the server apparatus among the first control unit, the second control unit, the determining unit, and the third control unit and the input device.
